(19) United States
(12) Patent Application Publication
(10) Pub. No.: US 2026/0005307 A1
(43) Pub. Date: Jan. 1, 2026

(54) Lithium Secondary Battery

(71) Applicant: SK On Co., Ltd., Seoul (KR)

(72) Inventors: Geum Yong PARK, Daejeon (KR); In Haeng CHO, Daejeon (KR)

(21) Appl. No.: 19/250,761

(22) Filed: Jun. 26, 2025

(30) Foreign Application Priority Data
Jul. 1, 2024 (KR) 10-2024-0086370

(51) Int. Cl. H01M 10/0567; H01M 4/02; H01M 4/131; H01M 4/505; H01M 4/525; H01M 10/0525; H01M 10/0568; H01M 10/0569

(52) U.S. Cl. CPC H01M 10/0567; H01M 4/131; H01M 4/505; H01M 4/525; H01M 10/0568; H01M 10/0569; H01M 2004/028; H01M 10/0525

(57) ABSTRACT

A lithium secondary battery according to the present disclosure includes: a cathode which includes a cathode active material layer including a lithium transition metal oxide; an anode disposed opposite to the cathode and including an anode active material layer, and an electrolyte which includes a lithium salt, a solvent including a carbonate solvent and an ether solvent, and lithium nitrate (LiNO₃). In the electrolyte, a lithium nitrate dissolution ratio, defined by Equation 1, in the electrolyte is 0.01 to 0.07.

### CROSS-REFERENCE TO RELATED APPLICATIONS

This patent application claims the priority and benefits of Korean Patent Application No. 10-2024-0086370 filed on Jul. 1, 2024, the disclosure of which is incorporated herein by reference in its entirety.

### BACKGROUND OF THE INVENTION

### 1. Field of the Invention

The present disclosure provides a lithium secondary battery

### 2. Description of the Related Art

A secondary battery is a battery that can be repeatedly charged and discharged. With the rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as a hybrid vehicle as a power source thereof.

Examples of the secondary batteries may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design, such that development thereof is progressing in this regard.

As the application range of lithium secondary batteries expands, longer cycle life, higher capacity, and improved operational stability are required. For example, the output characteristics and cycle life characteristics of the lithium secondary battery may deteriorate due to side reactions between a cathode active material and an electrolyte in the lithium secondary battery.

### SUMMARY OF THE INVENTION

An object of the present disclosure is to provide a lithium secondary battery with improved electrochemical characteristics.

A lithium secondary battery according to exemplary embodiments of the present disclosure includes: a cathode which includes a cathode active material layer including a lithium transition metal oxide; an anode disposed opposite to the cathode; and an electrolyte which includes a lithium salt, a solvent including a carbonate solvent and an ether solvent, and lithium nitrate (LiNO₃). In the electrolyte, a lithium nitrate dissolution ratio, defined by Equation 1 below, in the electrolyte is 0.01 to 0.07.

$$Lithium nitrate dissolution ratio = A / B \qquad [ Equation 1 ]$$

In Equation 1, A is a content of the lithium nitrate, expressed in parts by weight per 100 parts by weight based on the total of the lithium salt and the solvent, and B is a content of the ether solvent, expressed in volume % based on the total volume of the solvent.

In exemplary embodiments, A in Equation 1 may be 0.01 parts by weight to 3 parts by weight. In exemplary embodiments, A in Equation 1 may be 0.05 parts by weight to 0.5 parts by weight.

In exemplary embodiments, B in Equation 1 may be 1 volume % to 10 volume %.

In exemplary embodiments, the ether solvent may include at least one selected from the group consisting of ethylene glycol dimethyl ether, dimethyl ether, diethylene glycol diethyl ether, triethylene glycol dimethyl ether, triethylene glycol diethyl ether, dibutyl ether, diethyl ether, dipropyl ether, diethylene glycol dimethyl ether, 1,3-dioxolane, 4-methyldioxolane and 1,4-dioxane.

In exemplary embodiments, the carbonate solvent may include a linear carbonate solvent and a cyclic carbonate solvent.

In exemplary embodiments, a ratio of the volume of the linear carbonate solvent to the volume of the cyclic carbonate sol vent may be 2 to 5.

In exemplary embodiments, the content of the lithium salt may be 0.5 M to 2 M.

In exemplary embodiments, the electrolyte may further include an auxiliary additive including at least one selected from the group consisting of an unsaturated cyclic carbonate compound, a halogen-substituted cyclic carbonate compound, a fluorine-substituted phosphate compound, an oxalato phosphate compound, a sultone compound, a sulfate compound and a sulfite compound.

In exemplary embodiments, the auxiliary additive may include a halogen-substituted cyclic carbonate compound, an oxalato phosphate compound, a sultone compound and a sulfate compound.

In exemplary embodiments, the content of the auxiliary additive may be 0.01% by weight to 5% by weight based on the total weight of the electrolyte.

In exemplary embodiments, the lithium transition metal oxide may include at least one of nickel, cobalt and manganese.

In exemplary embodiments, the lithium transition metal oxide may include nickel, and a content of nickel based on the total number of moles of elements excluding lithium and oxygen in the lithium transition metal oxide may be 50 mol % or more.

In the lithium secondary battery according to exemplary embodiments of the present disclosure, a low-resistance film derived from lithium nitrate included in the electrolyte may be formed on the electrode surface during the charging and discharging process.

Accordingly, the internal resistance of the battery may be reduced, and when a high current density is applied, the capacity of the battery may be increased and the overvoltage may be reduced. In addition, the fast charging characteristics and cycle life characteristics of the battery may be improved.

The lithium secondary battery of the present disclosure may be widely applied in green technology fields, such as electric vehicles, battery charging stations, as well as solar power generation, wind power generation, and the like, which use the batteries. In addition, the lithium secondary battery of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a plan view of a lithium secondary battery according to one embodiment, and

FIG. 2 is a schematic cross-sectional view of the lithium secondary battery according to one embodiment.

### DETAILED DESCRIPTION OF THE INVENTION

A lithium secondary battery of the present disclosure includes a cathode including a lithium transition metal oxide and an electrolyte including lithium nitrate and an ether solvent.

Hereinafter, the present disclosure will be described in detail through embodiments with reference to the accompanying drawings. However, the embodiments are merely illustrative and the present disclosure is not limited to the specific embodiments described by way of example.

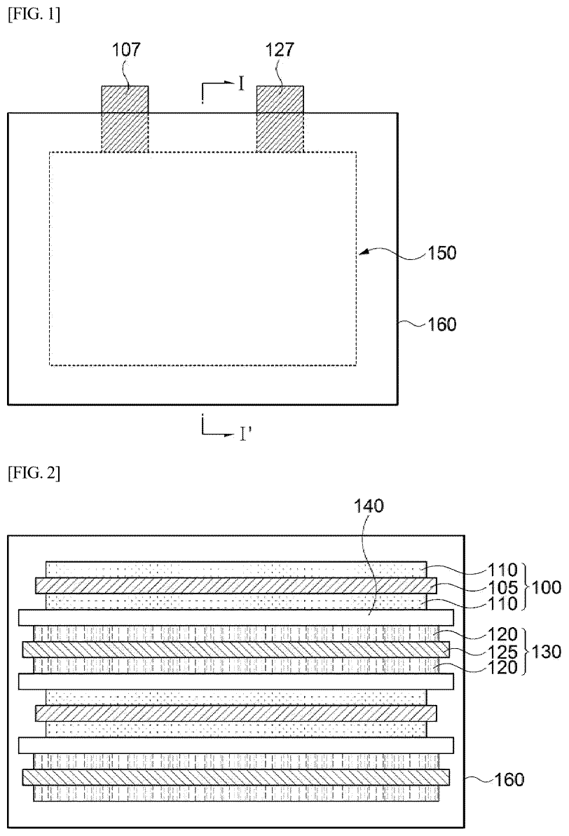

FIGS. 1 and 2 are schematic plan and cross-sectional views illustrating a lithium secondary battery according to exemplary embodiments, respectively. For example, FIG. 2 is a cross-sectional view taken along line I-I′ in FIG. 1.

Referring to FIGS. 1 and 2, the lithium secondary battery may include a cathode 100 including a cathode active material and an anode 130 disposed opposite to the cathode 100.

The cathode 100 may include a cathode current collector 105 and a cathode active material layer 110 disposed on at least one surface of the cathode current collector 105.

The cathode current collector 105 may include stainless steel, nickel, aluminum, titanium, or an alloy thereof. The cathode current collector 105 may also include aluminum or stainless steel having a surface treated with carbon, nickel, titanium or silver. For example, the cathode current collector 105 may have a thickness of 10 μm to 50 μm.

The cathode active material layer 110 may include a cathode active material. The cathode active material may include a compound capable of reversibly intercalating and deintercalating lithium ions.

According to exemplary embodiments, the cathode active material may include a lithium transition metal oxide. The lithium transition metal oxide may further include at least one of cobalt (Co), manganese (Mn) and aluminum (Al).

In some embodiments, the lithium transition metal oxide may include a layered structure or a crystal structure represented by Formula 1 below.

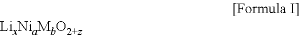

In Formula 1, x, a, b and z may satisfy 0.95≤x≤1.2, 0.5≤a≤0.99, 0.01≤b≤0.5, and −0.5≤z≤0.1. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of the additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form a bond, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag Zn, B, Al, Ga, C, Si, Sn, Sr, Ba, Ra, P and Zr. The auxiliary element may also act, for example, as an auxiliary active element which contributes to the capacity/output activity of the cathode active material together with Co or Mn like Al.

For example, the lithium transition metal oxide may include a layered structure or a crystal structure represented by Formula 2 below.

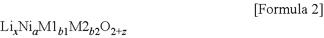

In Formula 2, M1 may include Co, Mn and/or Al. M2 may include the above-described auxiliary elements. In Formula 2, x, a, b1, b2 and z may satisfy 0.95≤x≤1.2, 0.5≤a≤0.99, 0.01≤b1+b2≤0.5, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of lithium transition metal oxide particles, or may penetrate through the surface of the lithium transition metal oxide particles to become incorporated into the bonding structure represented by Formula 1 or Formula 2.

The lithium transition metal oxide may include at least one of nickel, cobalt and manganese. For example, the lithium transition metal oxide may include nickel, cobalt and manganese.

Nickel may be provided as a transition metal associated with the output and capacity of the lithium secondary battery. Therefore, as described above, by employing a high-nickel-content (high-Ni) composition in the cathode active material, a high-capacity cathode and a high-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity. In addition, a phosphate-based additive may stabilize the interface of the cathode active material including a high content of nickel, so that the high-temperature cycle life characteristics may be improved, and resistance may be reduced.

When the lithium transition metal oxide includes nickel, a content of nickel based on the total number of moles of elements excluding lithium and oxygen (for example, the molar fraction of nickel based on the total number of moles of nickel, cobalt and manganese) in the lithium transition metal oxide may be 50 mol % or more, 60 mol % or more, 70 mol % or more, or 80 mol % or more. In some embodiments, the content of nickel may be 80 mol % to 95 mol %, 82 mol % to 95 mol %, 83 mol % to 95 mol %, 84 mol % to 95 mol %, 85 mol % to 95 mol %, or 88 mol % to 95 mol %.

In some embodiments, the cathode active material may include a lithium cobalt oxide-based active material, a lithium manganese oxide-based active material, or a lithium nickel oxide-based active material.

In some embodiments, the cathode active material may include a lithium iron phosphate (LFP)-based active material represented by Formula 3 below. For example, the LFP active material may be LiFePO₄. The LFP active material may be structurally more stable than the NCM-based active material, thereby exhibiting high cycle life characteristics and high stability. In a secondary battery using the LFP active material as the cathode active material, the cycle life characteristics may be further improved and the resistance may be further reduced by including the above-described phosphate-based additive.

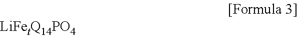

In Formula 3, t may be in the range of 0<t≤1, and Q may include at least one of Na, Mg, Ca, Y, Ti, Hf, V, Nb, Ta, Cr, Mo, W, Cu, Ag, Zn, B, Al, Ga, C, Si, Sn, Sr, Ba, Ra, P or Zr.

In some embodiments, the cathode active material may include, for example, a manganese (Mn)-rich active material, a lithium (Li)-rich layered oxide (LLO)/over-lithiated oxide (OLO)-based active material, or a cobalt (Co)-less active material, which have a chemical structure or a crystal structure represented by Formula 4.

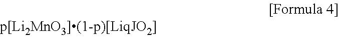

In Formula 4, p and q may satisfy 0<p<1 and 0.9≤q≤1.2, and J may include at least one element selected from Mn, Ni, Co, Fe, Cr, V, Cu, Zn, Ti, Al, Mg and B.

For example, a cathode slurry may be prepared by mixing the cathode active material in a solvent. The cathode slurry may be applied to the cathode current collector, and then dried and roll-pressed to prepare the cathode active material layer 110. Specifically, the cathode slurry may be coated on the cathode current collector 105, followed by drying and roll-pressing, to prepare the cathode active material layer 110. The coating process may be performed using methods such as gravure coating, slot die coating, simultaneous multilayer die coating, imprinting, doctor blade coating, dip coating, bar coating or casting, etc., but it is not limited thereto. The cathode active material layer 110 may further include a binder, and optionally may further include, a conductive material, a thickener or the like.

Non-limiting examples of the solvent used in the preparation of the cathode active material layer 110 may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly (butadiene) rubber (BR), styrene-butadiene rubber (SBR) and the like. In one embodiment, a PVDF-based binder may be used as the cathode binder.

The conductive material may be added to the cathode active material layer 110 to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCFs), carbon fibers, and/or metal-based conductive materials, including perovskite materials, such as tin, tin oxide, titanium oxide, LaSrCoO₃, and LaSrMnO₃, but is not limited thereto

The cathode active material layer 110 may further include a thickener and/or a dispersant. For example, the cathode active material layer 110 may include a thickener such as carboxy methyl cellulose (CMC).

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more thereof. For example, the anode current collector 125 may have a thickness of 10 μm to 50 μm.

The anode active material layer 120 may include an anode active material. As the anode active material, a material capable of intercalating and deintercalating lithium ions may be used. For example, as the anode active material, carbon-based materials such as crystalline carbon, amorphous carbon, a carbon composite, or carbon fibers, etc.; lithium metal; a lithium alloy, a silicon (Si)-containing material or a tin (Sn)-containing material, etc. may be used. These may be used alone or in combination of two or more thereof.

The amorphous carbon may include hard carbon, soft carbon, cokes, mesocarbon microbead (MCMIB), mesophase pitch-based carbon fiber (MPCF) or the like.

The crystalline carbon may include graphite-based carbon such as natural graphite, artificial graphite, graphite cokes, graphite MCMB, graphite MPCF or the like.

The lithium metal may include pure lithium metal and/or lithium metal having a protective layer formed thereon for suppressing dendrite growth and the like. In one embodiment, a lithium metal-containing layer deposited or coated on the anode current collector 125 may also be used as the anode active material layer 120. In one embodiment, a lithium thin film layer may also be used as the anode active material layer 120.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity characteristics. The silicon-containing material may include Si, SiOₓ (0<x<2), metal-doped SiOₓ (0<x<2), a silicon-carbon composite, etc.

The metal may include lithium and/or magnesium, and the metal-doped SiOₓ (0<x<2) may include a metal silicate.

The anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting, etc. The anode active material layer 120 may further include a binder, and optionally may further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when preparing the cathode 100 as the binder, conductive material and thickener may also be used for the anode.

In some embodiments, a styrene-butadiene rubber (SBR)-based binder, carboxymethyl cellulose (CMC), polyacrylic acid-based binder, poly (3,4-ethylenedioxythiophene) (PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow a flow of ions therethrough. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, an electrode cell may be defined by the cathode 100, the anode 130 and the separation membrane 140, and a plurality of electrode cells may be stacked to form, for example, a jelly roll-type electrode assembly 150. For example, the electrode assembly 150 may be formed by winding, stacking, z-folding, or stack-folding the separation membrane 140.

The electrode assembly 150 may be accommodated in a case 160 together with the electrolyte to define a lithium secondary battery. According to exemplary embodiments, a non-aqueous electrolyte may be used as the electrolyte.

The electrolyte includes lithium nitrate (LiNO₃). As the battery is repeatedly charged and discharged, lithium nitrate may decompose on the electrode surface to form an interfacial film with low electrical resistance. The interfacial film may include lithium nitride, and thus, the electron transfer resistance at the interface between the electrolyte and the electrode may be reduced, thereby decreasing the internal resistance of the battery.

The content of the lithium nitrate may be 0.01 to 3 parts by weight (“wt parts”) based on 100 wt parts based on the total of the solvent and the lithium salt described below. In some embodiments, the content of the lithium nitrate may be 0.05 to 0.5 wt parts or 0.1 to 0.3 wt parts based on 100 wt parts based on the total of the solvent and the lithium salt described below.

Within the above range, a low-resistance film at the interface between the electrode and the electrolyte may be formed with an appropriate thickness, and degradation in battery performance due to excessive lithium nitrate may be prevented.

The electrolyte includes a solvent including a carbonate solvent and an ether solvent. The carbonate sol vent has high polarity and high chemical stability, so it may function as a migration medium for lithium ions, and the ether solvent may be used to improve the solubility of lithium nitrate.

In an exemplary embodiment, the ether solvent may include ethylene glycol dimethyl ether, dimethyl ether, diethylene glycol diethyl ether, triethylene glycol dimethyl ether, triethylene glycol diethyl ether, dibutyl ether, diethyl ether, dipropyl ether, diethylene glycol dimethyl ether, 1,3-dioxolane, 4-methyldioxolane, 1,4 dioxane and the like. These may be used alone or in combination of two or more thereof. For example, the ether solvent may include ethylene glycol dimethyl ether.

In exemplary embodiments, the content of the ether solvent may be 1 vol % to 10 vol % based on the total volume of the solvent. In some embodiments, the content of the ether solvent may be 3 vol % to 9 vol %, or 4 vol % to 7 vol % based on the total volume of the solvent.

Within the above range, the solubility of lithium nitrate may be sufficiently improved, thereby preventing deterioration in the lithium ion mobility of the electrolyte.

In an exemplary embodiment, the carbonate solvent may include a linear carbonate solvent and a cyclic carbonate solvent.

The cyclic carbonate solvent may include, for example, propylene carbonate (PC), ethylene carbonate (EC), butylene carbonate and the like. These may be used alone or in combination of two or more thereof. For example, the cyclic carbonate solvent may include propylene carbonate and ethylene carbonate.

The linear carbonate solvent may include diethyl carbonate (DEC), dimethyl carbonate (DMC), ethyl methyl carbonate (EMC), methyl propyl carbonate, ethyl propyl carbonate, dipropyl carbonate and the like. These may be used alone or in combination of two or more thereof. For example, the linear carbonate solvent may include ethyl methyl carbonate.

In exemplary embodiments, a ratio of the volume of the linear carbonate solvent to the volume of the cyclic carbonate solvent may be 2 to 5. In some embodiments, the ratio of the volume of the linear carbonate sol vent to the volume of the cyclic carbonate solvent may be 2.5 to 4.5.

In exemplary embodiments, the content of the linear carbonate solvent may be 50 vol % to 90 vol % based on the total volume of the solvent. In some embodiments, the content of the linear carbonate solvent may be 60 vol % to 80 vol % based on the total volume of the solvent.

In exemplary embodiments, the content of the cyclic carbonate solvent may be 10 vol % to 40 vol % based on the total volume of the solvent. In some embodiments, the content of the cyclic carbonate solvent may be 15 vol % to 35 vol % based on the total volume of the solvent.

The solvent may further include other sol vents of different chemical species from those of the carbonate solvent and the ether solvent. For example, the other solvents may include ester solvents, ketone solvents, alcohol solvents, aprotic solvents and the like. These may be used alone or in combination of two or more thereof.

The ester solvent may include, for example, methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), gamma-butyrolactone (GBL), decanolide, valerolactone, mevalonolactone, caprolactone and the like.

The ketone solvent may include, for example, cyclohexanone.

The alcohol solvent may include, for example, ethyl alcohol, isopropyl alcohol and the like.

The aprotic solvent may include, for example, dimethyl sulfoxide, acetonitrile, sulfolane, propylene sulfite and the like.

The electrolyte includes a lithium salt. The lithium salt may be expressed as Li⁺X⁻, for example, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)P⁻, CF₃SO₃⁻, CF₃CF₂SO₃⁻, (CF₃SO₂)₂N⁻; (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻; and (CF₃CF₂SO₂)₂N⁻ may be exemplified. These may be used alone or in combination of two or more thereof.

In some embodiments, the lithium salt may include at least one selected from the group consisting of lithium tetrafluoroborate (LiBF₄), lithium hexafluorophosphate (LiPF₆), and lithium difluorophosphate (LiPO₂F₂). Accordingly, the transfer of lithium ions may be further promoted during charging and discharging of the lithium secondary battery. As a result, the capacity characteristics of the lithium secondary battery may be further improved.

In an exemplary embodiment, the content of the lithium salt may be 0.5 M to 2 M. In some embodiments, the content of the lithium salt may be 0.7 M to 1.5 M. Within the above range, the transfer of lithium ions and/or electrons may be promoted during charging and discharging of the lithium secondary battery, thereby improving the capacity characteristics.

According to exemplary embodiments, a lithium nitrate dissolution ratio, defined by Equation 1 below, in the electrolyte may be 0.01 to 0.07. In some embodiments, the lithium nitrate dissolution ratio may be 0.015 to 0.06, 0.02 to 0.06, or 0.02 to 0.04.

$$Lithium nitrate dissolution ratio = A / B \qquad [ Equation 1 ]$$

In Equation 1, A is a content of the lithium nitrate, expressed in weight parts per 100 weight parts based on the total of the lithium salt and the solvent, and B is a content of the ether solvent, expressed in volume % based on the total volume of the solvent.

Within the above range, a low-resistance film on the electrode surface may be formed with an appropriate thickness, thereby sufficiently reducing the internal resistance of the battery.

If the lithium nitrate dissolution ratio is less than 0.01, a low-resistance film may not be formed with sufficient thickness on the electrode surface, thereby increasing the internal resistance of the battery.

If the lithium nitrate dissolution ratio exceeds 0.07, lithium nitrate may be included in an excessive amount relative to its solubility in the solvent and may be precipitated during battery operation.

The precipitated lithium nitrate may hinder the migration of lithium ions as a solid or may crystallize inside the battery, thereby impairing the cycle life characteristics of the battery.

In an exemplary embodiment, A in Equation 1 may be 0.01 wt parts or more, 0.02 wt parts or more, or 0.03 wt parts or more, and 0.07 wt parts or less, 0.06 wt parts or less, 0.05 wt parts or less, or 0.04 wt parts or less.

In an exemplary embodiment, B in Equation 1 may be 1 vol % or more, 2 vol % or more, 3 vol % or more, 4 vol % or more, or 5 vol % or more, and 10 vol % or less, 9 vol % or less, 8 vol % or less, 7 vol % or less, or 6 vol % or less.

In an exemplary embodiment, the electrolyte may further include an auxiliary additive including an unsaturated cyclic carbonate compound, a halogen-substituted cyclic carbonate compound, a fluorine-substituted phosphate compound, an oxalato phosphate compound, a sultone compound, a sulfate compound, a sulfite compound and the like.

For example, the auxiliary additive may include a halogen-substituted cyclic carbonate compound, an oxalato phosphate compound, a sultone compound, and a sulfate compound.

The cyclic carbonate compound may include vinylene carbonate (VC), vinyl ethylene carbonate (VEC) and the like.

The halogen-substituted cyclic carbonate compound may include fluoroethylene carbonate (FEC) and the like.

The sultone compound may include saturated sultone compounds such as 1,3-propane sultone (PS), 1,4 butane sultone, and the like, or unsaturated sultone compounds such as 1,3-propene sultone (PRS) and the like.

The sulfate compound may include cyclic sulfate compounds such as 1,2-ethylene sulfate, 1,2-propylene sulfate and the like.

The sulfite compound may include cyclic sulfite compounds such as ethylene sulfite, butylene sulfite and the like.

The phosphate compound may include lithium difluoro bis-oxalato phosphate, lithium difluoro phosphate, lithium oxalato phosphate and the like.

The borate compound may include lithium bis(oxalate) borate and the like.

In an exemplary embodiment, the content of the auxiliary additive may be 0.01% by weight (“wt %”) to 5 wt % based on the total weight of the electrolyte. In some embodiments, the content of the auxiliary additive may be 0.05 wt % to 3 wt % or 0.1 wt % to 2 wt % based on the total weight of the electrolyte.

Within the above range, the resistance of the film formed at the interface between the electrode and the electrolyte may be reduced, and the electrical conductivity and lithium ion mobility of the electrolyte may be improved.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### (1) Preparation of Electrolyte

An electrolyte was prepared by adding 0.1 wt parts of lithium nitrate to 100 wt parts of a solution in which 1.1 M LiPF₆ was dissolved in a solvent including ethylene carbonate (EC), propylene carbonate (PC), ethyl methyl carbonate (EMC), and ethylene glycol dimethyl ether (dimethoxyethane, DME) in a volume ratio of 10:15:70:5, and further adding 5.0 wt % of fluoroethylene carbonate (FEC), 1.0 wt % of lithium difluorophosphate, 0.3 wt % of 1,3-propene sultone (PRS; prop-1-ene-1,3-sultone), 0.5 wt % of 1,3-propane sultone (PS), and 0.5 wt % of ethylene sulfate (ESA) to the solution.

### (2) Manufacture of Lithium Secondary Battery

LiNi_{0.88}Co_{0.06}Mn_{0.06}O₂ as a cathode active material, polyvinylidene fluoride (PVdF) as a binder, and carbon as a conductive material were mixed in a weight ratio of 98:1:1, and then dispersed in N-methyl-2-pyrrolidone to prepare a cathode slurry. The slurry was coated on an aluminum foil having a thickness of 12 μm, and then dried and roll-pressed to fabricate a cathode.

Artificial graphite and natural graphite as anode active materials, styrene-butadiene rubber as a binder, and carboxymethyl cellulose as a thickener were mixed in a weight ratio of 96:2:2, and then dispersed in water to prepare an anode active material slurry. The slurry was coated on a copper foil having a thickness of 8 μm, and then dried and roll-pressed to fabricate an anode.

A film separator made of polyethylene (PE) material with a thickness of 13 μm was stacked between the fabricated electrodes, and a cell was assembled using a pouch having dimensions of 5 mm (thickness)×50 mm (width)×60 mm (length). Then, the non-aqueous electrolyte was injected into the pouch to manufacture a 2 Ah-class lithium secondary battery for an electric vehicle (EV).

### Example 2

An electrolyte and a battery were manufactured in the same manner as in Example 1, except that lithium nitrate was added to the solution in an amount of 0.2 wt parts.

### Example 3

An electrolyte and a battery were manufactured in the same manner as in Example 1, except that lithium nitrate was added to the solution in an amount of 0.3 wt parts.

### Comparative Example 1

An electrolyte and a battery were manufactured in the same manner as in Example 1, except that lithium nitrate was added to the solution in an amount of 0.4 wt parts.

### Comparative Example 2

An electrolyte and a battery were manufactured in the same manner as in Example 1, except that lithium nitrate was not used.

### Comparative Example 3

A solvent including ethylene carbonate (EC), propylene carbonate (PC), and ethyl methyl carbonate (EMC) in a volume ratio of 10:15:75 was used, but lithium nitrate did not dissolve, making it impossible to prepare an electrolyte with a uniform composition.

### Comparative Example 4

An electrolyte and a battery were manufactured in the same manner as in Example 1, except that a solvent including ethylene carbonate (EC), propylene carbonate (PC), and ethyl methyl carbonate (EMC) in a volume ratio of 10:15:75 was used, and lithium nitrate was not used.

### Experimental Example

Evaluations were performed on the lithium secondary batteries of the examples and comparative examples as described in the following experimental examples, and the results are shown in Table 1.

### (1) Evaluation of Initial Performance

### 1) Measurement of Initial Discharge Capacity

The lithium secondary batteries according to the examples and comparative examples were charged (CC-CV 0.5C 4.2V 0.05C CUT-OFF) and discharged (CC 0.5C 2.7V CUT-OFF) three times each at 25° C., and the discharge capacity at the third cycle was measured.

### 2) Measurement of Initial Coulombic Efficiency

The lithium secondary batteries according to the examples and comparative examples were charged (CC-CV 0.5C 4.2V 0.05C CUT-OFF) and discharged (CC 0.5C 2.7V CUT-OFF) three times each at 25° C., and the Coulombic efficiency was calculated as the ratio of the discharge capacity to the charge capacity.

### 3) Measurement of Initial Internal Resistance (C-DCIR, D-DCIR)

The lithium secondary batteries of the examples and comparative examples were subjected to 0.5C CC/CV charge (4.2V 0.05C CUT-OFF) at 25° C., and then 0.5C CC discharge up to a state of charge (SOC) of 60%. At the SOC 60 point, the batteries were discharged and supplementarily charged for 10 seconds, respectively, while varying the C-rate to 0.2C, 0.5C, 1C, 1.5C, 2C and 2.5C, and then the C-DCIR and D-DCIR were measured.

### (2) Evaluation of Low-Temperature Power

### 1) Measurement of Low-Temperature Discharge Capacity

The lithium secondary batteries according to the examples and comparative examples were charged (CC-CV 0.5C 4.2V 0.05C CUT-OFF) and discharged (CC 0.5C 2.7V CUT-OFF) three times each at −10° C., and the discharge capacity at the third cycle was measured.

### 2) Measurement of Low-Temperature Internal Resistance

The lithium secondary batteries of the examples and comparative examples were subjected to 0.5C CC/CV charge (4.2V 0.05C CUT-OFF) at −10° C., and then 0.5C CC discharge up to a state of charge (SOC) of 60%. At the SOC 60 point, the batteries were discharged and supplementarily charged for 10 seconds, respectively, while varying the C-rate to 0.2C, 0.5C, 1C, 1.5C, 2C and 2.5C, and then the DCIR was measured.

TABLE 1

| | Initial performance | | | | | | | |
|---|---|---|---|---|---|---|---|---|
| | | Initial | | Capacity_{—} | | | Low-temperature | |
| | Capacity_{—} | Coulombic | Capacity_{—} | 3 C/ | | | performance | |
| | 0.5 C | efficiency | 3 C | Capacity_{—} | D_DCIR | C_DCIR | Capacity | DCIR |
| | (mAh) | (%) | (mAh) | 0.5 C (%) | (mΩ) | (mΩ) | (mAh) | (mΩ) |
| Example 1 | 1963 | 84.8 | 945 | 48.1 | 27.8 | 24.7 | 1515 | 124.4 |
| Example 2 | 1954 | 84.5 | 979 | 50.1 | 26.4 | 23.8 | 1498 | 124.3 |
| Example 3 | 1958 | 85 | 1042 | 53.2 | 27.3 | 25.7 | 1513 | 124.9 |
| Comparative | 1855 | 61.9 | — | — | — | — | — | — |
| Example 1 | | | | | | | | |
| Comparative | 1963 | 84.8 | 912 | 46.5 | 28.0 | 25.9 | 1501 | 130.1 |
| Example 2 | | | | | | | | |
| Comparative | 1952 | 85 | 817 | 41.9 | 28.5 | 27.3 | 1486 | 133.1 |
| Example 4 | | | | | | | | |

Referring to Table 1 above, the batteries of the examples were implemented as high-capacity and high-efficiency lithium batteries by including an electrolyte having a lithium nitrate dissolution ratio of 0.01 to 0.07. In addition, the batteries of the examples showed no significant decrease in capacity even in a low-temperature environment, and exhibited low internal resistance, thereby improving battery performance.

On the other hand, the batteries of the comparative examples exhibited deteriorated initial capacity and resistance characteristics compared to the batteries of the examples, and showed inferior performance even at low temperatures.

In particular, in the battery of Comparative Example 1, which included an electrolyte having a lithium nitrate dissolution ratio greater than 0.07, the efficiency of the battery was significantly reduced. In addition, excess lithium nitrate was not sufficiently dissolved in the electrolyte and precipitated, so the battery did not operate normally.

In the battery of Comparative Example 2, which had an electrolyte that did not include lithium nitrate, the resistance of the battery was higher than that of the batteries of the examples.

The electrolyte not including an ether solvent could not dissolve lithium nitrate, and therefore, could not be used to manufacture a battery (see Comparative Example 3).

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A lithium secondary battery comprising:
a cathode which comprises a cathode active material layer comprising a lithium transition metal oxide;
an anode disposed opposite to the cathode; and
an electrolyte which comprises a lithium salt, a solvent comprising a carbonate solvent and an ether solvent, and lithium nitrate (LiNO₃),
wherein a lithium nitrate dissolution ratio, defined by Equation 1 below, in the electrolyte is 0.01 to 0.07:
$$Lithium nitrate dissolution ratio = A / B \qquad [ Equation 1 ]$$
(in Equation 1, A is a content of the lithium nitrate, expressed in parts by weight per 100 parts by weight based on the total of the lithium salt and the solvent, and B is a content of the ether solvent, expressed in volume % based on the total volume of the solvent).

2. The lithium secondary battery according to claim 1, wherein A in Equation 1 is 0.01 parts by weight to 3 parts by weight.

3. The lithium secondary battery according to claim 1, wherein A in Equation 1 is 0.05 parts by weight to 0.5 parts by weight.

4. The lithium secondary battery according to claim 1, wherein B in Equation 1 is 1 volume % to 10 volume %.

5. The lithium secondary battery according to claim 1, wherein the ether solvent comprises at least one selected from the group consisting of ethylene glycol dimethyl ether, dimethyl ether, diethylene glycol diethyl ether, triethylene glycol dimethyl ether, triethylene glycol diethyl ether, dibutyl ether, diethyl ether, dipropyl ether, diethylene glycol dimethyl ether, 1,3-dioxolane, 4-methyldioxolane and 1,4-dioxane.

6. The lithium secondary battery according to claim 1, wherein the carbonate solvent comprises a linear carbonate solvent and a cyclic carbonate solvent.

7. The lithium secondary battery according to claim 6, wherein a ratio of the volume of the linear carbonate solvent to the volume of the cyclic carbonate solvent is 2 to 5.

8. The lithium secondary battery according to claim 1, wherein the content of the lithium salt is 0.5 M to 2 M.

9. The lithium secondary battery according to claim 1, wherein the electrolyte further comprises an auxiliary additive comprising at least one selected from the group consisting of an unsaturated cyclic carbonate compound, a halogen-substituted cyclic carbonate compound, a fluorine-substituted phosphate compound, an oxalato phosphate compound, a sultone compound, a sulfate compound and a sulfite compound.

10. The lithium secondary battery according to claim 9, wherein the auxiliary additive comprises a halogen-substituted cyclic carbonate compound, an oxalato phosphate compound, a sultone compound and a sulfate compound.

11. The lithium secondary battery according to claim 9, wherein the content of the auxiliary additive is 0.01% by weight to 5% by weight based on the total weight of the electrolyte.

12. The lithium secondary battery according to claim 1, wherein the lithium transition metal oxide comprises at least one of nickel, cobalt and manganese.

13. The lithium secondary battery according to claim 1, wherein the lithium transition metal oxide comprises nickel, and a content of nickel based on the total number of moles of elements excluding lithium and oxygen in the lithium transition metal oxide is 50 mol % or more.
